(19) United States
(12) Patent Application Publication
(10) Pub. No.: US 2014/0251472 A1
(43) Pub. Date: Sep. 11, 2014

(54) Overpressurization Bypass for Fluid Valve

(71) Applicant: J-MAC TOOL, INC., Fort Worth, TX (US)

(72) Inventor: Ross Woods, Arlington, TX (US)

(73) Assignee: J-MAC TOOL, INC., Fort Worth, TX (US)

(21) Appl. No.: 14/199,658

(22) Filed: Mar. 6, 2014

Related U.S. Application Data
(60) Provisional application No. 61/773,452, filed on Mar. 6, 2013.

(51) Int. Cl. F16K 17/00

(52) U.S. Cl. CPC F16K 17/00
USPC 137/599.11

(57) ABSTRACT

A bypass valve assembly configured to provide a secondary fluid passage around a valve. The secondary fluid passage includes a regulator device that selectively restricts the fluid flow through the secondary passage. During pressure spikes, the regulator device is configured to open so as to relieve pressure in the system and prevent failure of the valve.

### BACKGROUND

1. Field of the Invention

The application relates generally to bypass valves and, more particularly, to an assembly to regulate over-pressurization of bypass valves.

2. Description of Related Art

It is difficult to economically produce hydrocarbons from low permeability reservoir rocks. Oil and gas production rates are often boosted by hydraulic fracturing, a technique that increases rock permeability by opening channels through which hydrocarbons can flow to recovery wells. During hydraulic fracturing, a fluid is pumped into the earth under high pressure (sometimes as high as 50,000 PSI) where it enters a reservoir rock and cracks or fractures it. Large quantities of proppants are carried in suspension by the fluid into the fractures. When the pressure is released, the fractures partially close on the proppants, leaving channels for oil and gas to flow.

Typical sites may use one or more trucks holding specialized pumps for delivering fracture fluids at sufficiently high rates and pressures to complete a hydraulic fracturing procedure or “frac job.” These trucks are in fluid communication with the well through the use of tubing. To facilitate safety and servicing, a shut-off valve is located at selected locations in the tubing. An operator is able to rotate a valve to seal off an upstream end from a downstream end.

Conventional shut-off valves (plug valves) can be susceptible to failure as a result of excessive pressures in the tubing while the valve is in a closed position. Conventional shut-off valves include a singular passage through the valve body. A valve is used to regulate the passage of fluid through the valve body. When the valve is closed, excessive pressures can occur as a result of pressure spikes in the fluid system. Failure may occur during operation of the valve by an operator, or while the valve is closed and in a undisturbed state. During failure, shut-off valves can explode, or separate and send projectiles through the air causing harm and even death to operators. An operator is usually unaware of possible safety concerns while working around conventional shut-off valves.

Although great strides have been made in shut-off valves, considerable shortcomings remain.

### DESCRIPTION OF THE DRAWINGS

The novel features believed characteristic of the invention are set forth in the description. However, the invention itself, as well as a preferred mode of use, and further objectives and advantages thereof, will best be understood by reference to the following detailed description when read in conjunction with the accompanying drawings, wherein:

FIG. 1 is a perspective view of a bypass valve assembly according to the preferred embodiment of the present application;

FIG. 2 is a top view of the bypass valve assembly of FIG. 1;

FIG. 3 is an end view of the bypass valve assembly of FIG. 1;

FIG. 4 is a side view of the bypass valve assembly of FIG. 1;

FIG. 5 is a section view of the bypass valve assembly of FIG. 4 taken along the line V-V;

FIG. 6 is an enlarged section view of a regulator device used in the bypass channel of the bypass valve of FIG. 5 taken about area VI;

FIG. 7 is an alternative embodiment of the bypass valve assembly of FIG. 1;

FIG. 8 is a side view of the bypass valve assembly of FIG. 7 coupled to a fluid valve;

FIG. 9 is a section view of the bypass valve assembly of FIG. 8 taken along the line IX-IX; and

FIG. 10 is an enlarged section view of an alternative embodiment of the regulator device in FIGS. 5 and 6 taken about circle X.

While the system of the present application is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the present application as described herein.

### DETAILED DESCRIPTION OF THE PREFERRED EMBODIMENT

An illustrative embodiment of the invention is described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the device described herein may be oriented in any desired direction.

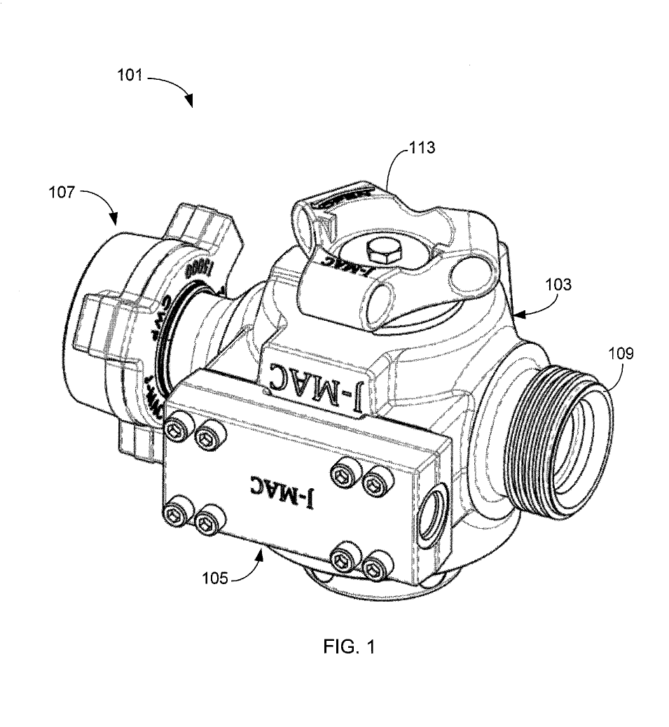

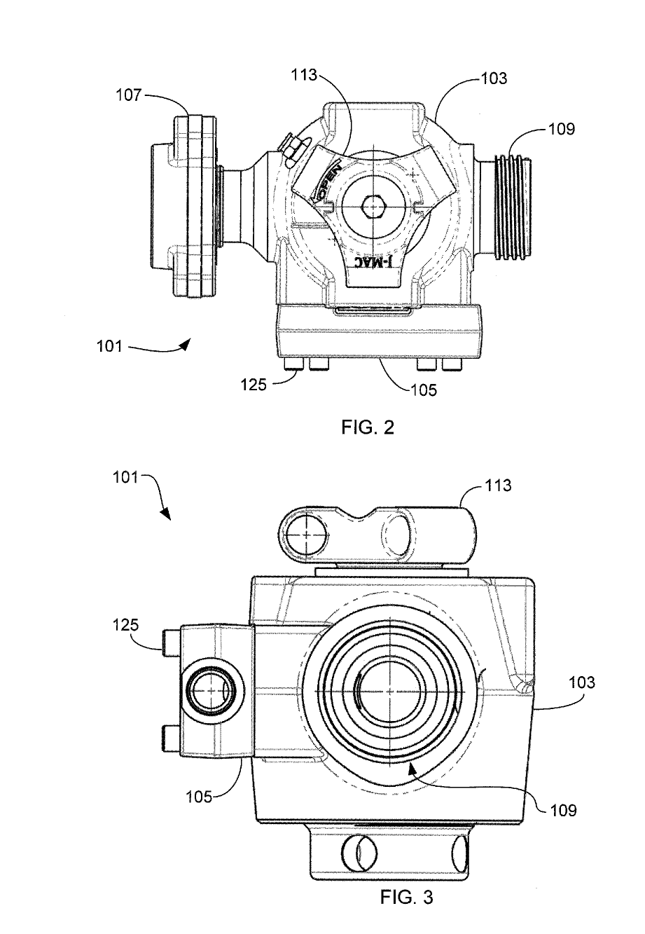

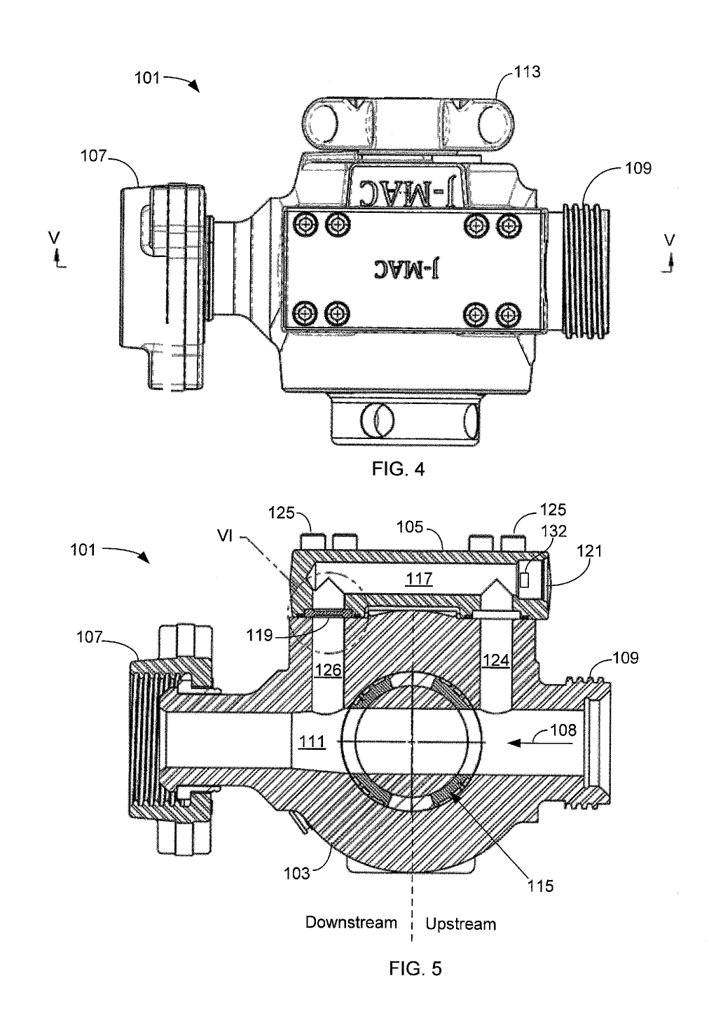

Referring to FIGS. 1-6 in the drawings, a bypass valve assembly is illustrated. Bypass valve assembly 101 is shown in FIG. 1. Valve assembly 101 includes a valve body 103 and a bypass housing 105. Valve assembly 101 is configured to regulate the flow of fluid passing through body 103. The flow of fluid may be permitted without substantial obstruction or may be partially or fully restricted as desired. Fluid is received from a tube or separate device (not shown) at one of a coupling end 107 and a threaded end 109. Fluid may enter and exit and either end 107,109 depending on the direction of fluid flow. For purposes herein, the direction of fluid flow is denoted by arrow 108. Therefore, body 103 is divided relatively equally into an upstream portion and a downstream portion. The portions denoted “upstream” and “downstream” can alternate depending on the direction of fluid flow. Ends 107 and 109 are configured to receive and mate with tubes or devices to permit the transportation of fluid.

Although selected types of connections are illustrated at ends 107 and 109, it is understood that ends 107 and 109 are not limited to incorporating such couplings, threads, or any other types of attachment means as illustrated or described. Ends 107 and 109 may be configured to incorporate any method of attachment to permit valve assembly 101 to be in fluid communication with one or more corresponding tubes and/or devices to deliver and receive fluid.

In particular with FIG. 5, a section view of bypass valve assembly 101 is illustrated. Body 103 includes a central channel 111 (primary passage) extending between ends 107 and 109 internally within body 103. Valve assembly 101 also includes a handle member 113 and a valve plug 115. Member 113 is externally coupled to body 103 while plug 115 is internally coupled to body 103. Plug 115 and member 113 are in operable communication with one another, such that as member 113 is moved, plug 115 is rotated. A user is able to open and close valve assembly 101 by actuating member 113, which in turn rotates plug 115 to selectively restrict fluid flow through central channel 111. Handle member 113 is configured to provide one or more surfaces to permit operation of valve plug 115 within central channel 111. Valve plug 115 is configured to selectively permit the passage of fluid through valve assembly 101. Valve plug 115 includes a bore 118 in coaxial alignment with central channel 111 when plug 115 is oriented in an open position. When open, plug 115 imposes minimal obstruction to the flow of fluid. When plug 115 is in a closed position, bore 118 is oriented perpendicularly to that of central channel 111, thereby causing plug 115 to fully restrict the flow of fluid through central channel 111. Other embodiments may use a valve system wherein valve plug 115 is configured to translate within portions of body 103 as opposed to rotate. A gate valve may be an example of such an alternative embodiment.

Although described as extending externally from body 103, it is understood that handle member 113 may be at least partially external or internal to body 103. Additionally, although described as using mechanical methods to rotate handle member 113, it is understood that handle member may be configured to operate with at least one of a mechanical, an electrical, or a pneumatic control system, to name a few. For example, a computerized device may be used to selectively rotate or operate handle member 113 and thereby selectively open and close valve plug 115 as desired. Furthermore, a pneumatic or hydraulic system may be used to operate valve plug 115 in another example. With both of the preceding examples, handle member 113 may or may not include external surfaces configured to permit the manual operation of valve plug 115.

As noted previously, at selected times a user may elect to close valve assembly 101. When closed, pressure variations exist in the fluid upstream or downstream. At times fluid pressures may spike beyond the physical limits of body 103. Valve assembly 101 is configured to regulate the maximum level of fluid pressure build up so as to prevent failure of body 103.

Bypass valve assembly 101 includes an upstream auxiliary channel 124 and a downstream auxiliary channel 126. Channels 124 and 126 are in fluid communication with central channel 111 in the respective upstream portion and downstream portion of body 103. Channels 124 and 126 are adjacent plug 115, but channels 124 and 126 are unobstructed by the operation of plug 115.

Valve assembly 101 further includes bypass housing 105. Bypass housing 105 includes a bypass channel 117 and a regulator device 119. Channel 117 is configured to be in fluid communication with auxiliary channels 124 and 126. Channel 117 acts to bridge the gap between channel 124 and channel 126. Channel 117 is a cylindrical tube capped in at least one end by a tube plug 121. Tube plug 121 is preferably welded to housing 105. Other embodiments may utilize other connections, such as threaded connections between tube plug 121 and housing 105, however, it has been found that such connections tend to be more apt to fail under increased pressures. Tube plug 121 is configured to prevent the loss of fluid through housing 105. Manufacturing of channel 117 necessitated the drilling through housing 105. Plug 121 seals the opening in housing 105 necessitating the flow of fluid through channels 124, 117, and 126.

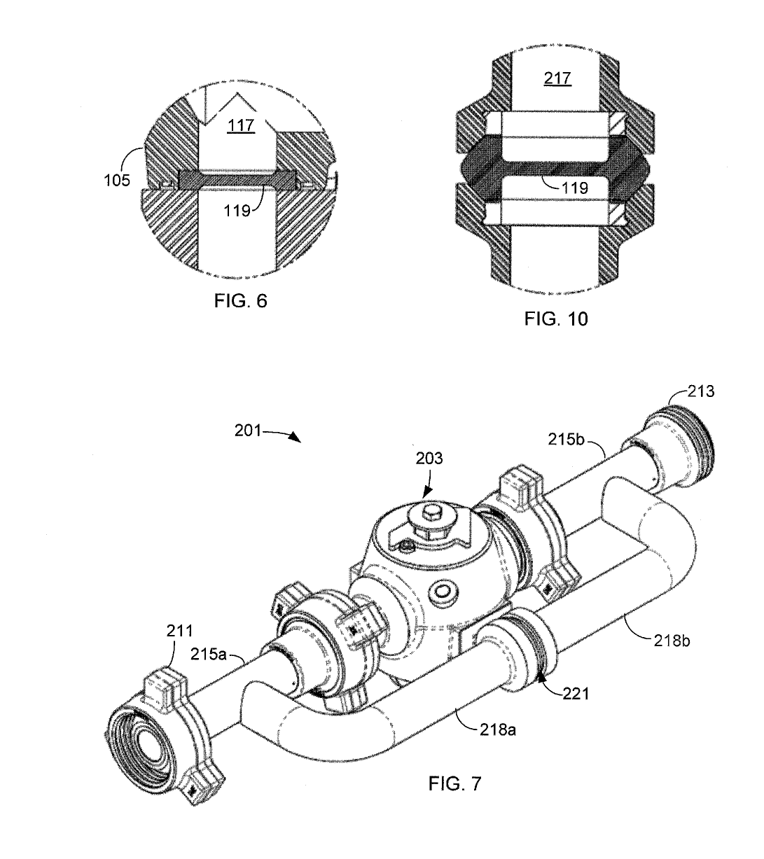

Bypass housing 105 is configured to selectively permit the passage of fluid around valve plug 115. The selective passage of fluid is in response to regulator device 119. Regulator device 119 is located in bypass channel 117 and is configured to selectively permit fluid flow around plug 115 in response to fluid pressure variations or pressure spikes. Regulator device is located along the intersection of housing 105 and body 103 adjacent auxiliary channel 126 in the downstream portion of body 103. Regulator device 119 is seen in more clarity in FIG. 6.

Regulator device 119 is in sealing engagement with housing 105 and body 103, such that fluid is not permitted to flow from auxiliary channel 124 to auxiliary channel 126, through bypass channel 117 under normal operating fluid pressures. When plug 115 is open, pressure spikes and pressure variations are configured to pass with the fluid through body 103. However, when plug 115 is closed, the fluid becomes relatively stagnant. Pressure variations and pressure spikes are absorbed by body 103 and other portions of valve assembly 101. Bypass valve assembly 101 is configured to withstand a maximum pressure before failure. When fluid pressures exceed the maximum pressure, or any predetermined pressure level, regulator device 119 is configured to rupture or open so as to permit the passage of fluid around valve plug 115. Ideally, regulator 119 is configured to maintain a maximum pressure rating lower than the maximum pressure rating of valve assembly 101. Regulator 119 is a safety feature to prevent the failure of valve assembly 101. It is understood that the pressure rating of regulator device 119 can vary. Valve assembly 101 may interchange regulator device 119 with other similar devices so as to adjust the maximum pressure rating.

In the preferred embodiment, regulator 119 is a mechanical device configured to selectively open, so as to permit fluid flow through channel 117 and bypass the valve plug 115. It is understood that other types of systems, electrical or pneumatic for example, may be used to monitor and activate regulator 119. With such systems, regulator device 119 may be configured to monitor the fluid pressure and automatically open so as to permit fluid flow through bypass channel 117. Bypass valve assembly 101 may also include a sensor to provide an operator with a visible or audible indication to an operator that regulator 119 has been opened. Any number of sensors and indicators may be used.

As seen in FIGS. 5 and 6, regulator 119 is located adjacent the mating surfaces of housing 103 and bypass housing 105. Bypass valve assembly 101 is configured to provide access to regulator 119 to permit the maintenance and/or replacement of regulator 119. Bypass housing 105 is coupled to housing 103 via a number of fasteners 125, such as bolts. Removal of fasteners 125 allow housing 105 to be separated from housing 103 and permit an operator access to regulator 119.

Valve assembly 101 may further include a sensor 132 in fluid communication with any one of channels 117, 124, and 126. Sensor 132 is configured to detect the rupture of regulator device 119 and provide a notification to an operator of such rupture. Sensor 132 is coupled to plug 121 and can be removed through removal of plug 121. Such a sensor would provide notice to the operator that a pressure spike has occurred in valve assembly 101 and that fluid is passing around valve plug 115. Sensor 132 may be a flow sensor or other type of sensor. It is understood that one or more sensors similar to that of sensor 132 may be used with valve assembly 101 to detect the flow of fluid through bypass channel 117 and are not limited to the location of tube plug 121.

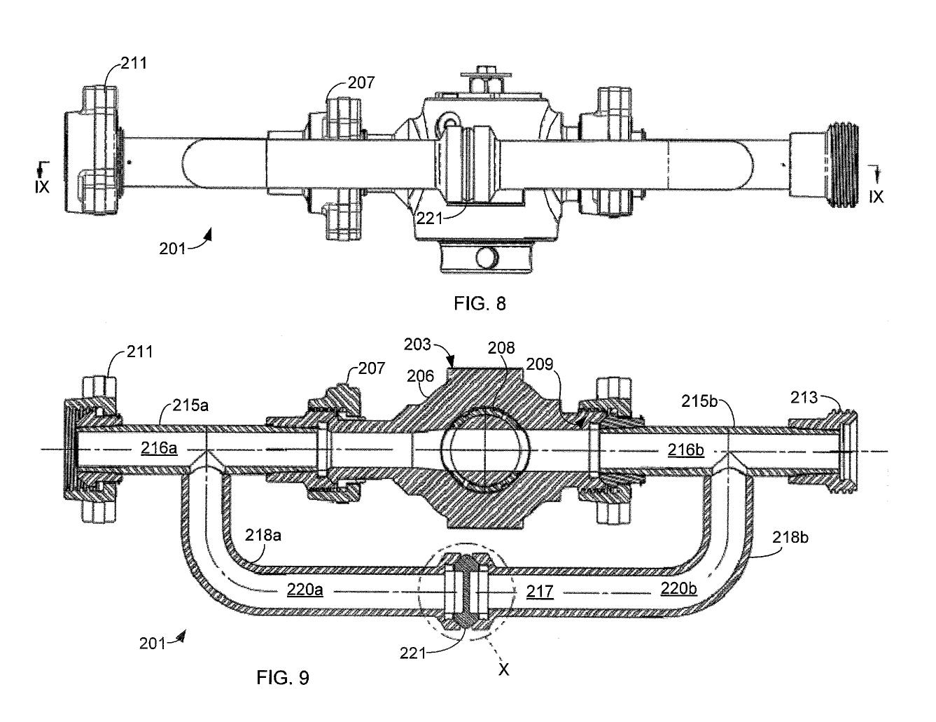

Referring now also to FIGS. 7-10 in the drawings, an alternative embodiment of bypass valve assembly 101 is illustrated. Bypass valve assembly 201 is configured as a retrofit assembly that is able to be used on conventional valve assemblies, such as valve 203. Valve 203 includes a valve plug 208 located within a valve body 206. Plug 208 operates in a similar form and function as described previously with respect to plug 115. In particular, as plug 208 is rotated between a first and second orientation, fluid flow through body 206 is selectively regulated. Valve 203 includes connectors 207 and 209 located on opposing sides of body 206. Connectors 207 and 209 are configured to sealingly engage valve 203 with adjoining tubing and devices for the passage of fluid. Connectors 207 and 209 are similar in form and function to that of ends 107 and 107 in FIGS. 1-6 above.

Valve assembly 201 is configured to provide an auxiliary bypass passage externally around a valve to act as a safety device to prevent fluid pressure from exceeding preselected levels. Bypass valve assembly 201 includes coupling members 215a and 215b. Coupling members 215a and 215b have a central passage 216a and 216b, respectively. Passages 216a and 216b are in coaxial alignment with one another. Each coupling member 215a and 215b includes a pair of fittings formed at opposing ends of each passage 216a and 216b. The fittings are configured to receive and mate with tubes or devices to permit the transportation of fluid.

Each coupling member 215a and 215b include a bypass tube 218a and 218b, respectively. Bypass tube 218a includes a bypass passage 220a. Passage 220a is in fluid communication with passage 216a. Bypass tube 218b includes a bypass passage 220b. Passage 220b is in fluid communication with passage 216b.

A bypass channel 217 is formed by the combination of passages 220a and 220b. For purposes herein, the singular reference to channel 217 will refer to both passage 220a and passage 220b. Bypass valve 201 further includes a regulator device 221 similar in form and function to that of regulator device 119. Regulator device 221 is in sealing engagement between tube 218a and tube 218b, such that fluid is not permitted to flow through channel 217 when the fluid pressure is below a preselected pressure value. Therefore, regulator device 221 selectively obstructs the passage of fluid through channel 217 in response to fluid pressure levels. Regulator 221 is configured to permit the passing of fluid through channel 217 if the pressure within the assembly exceeds a preselected value. For example, the preselected value may be 20,000 PSI. If the fluid pressure remains below the preselected value, regulator device 221 remains a complete obstruction to the passing of fluid flow through channel 217.

In the preferred embodiment, regulator 221 is a mechanical device configured to selectively rupture or open, so as to permit fluid flow through channel 217. It is understood that other types of systems, electrical or pneumatic for example, may be used to monitor and activate regulator 221. Bypass tubes 218a and 218b are coupled together around regulator device 221 with the use of fittings and clamping mechanisms. Regulator device 221 is removeable and interchangeable via removal of the fittings and clamping mechanisms.

Regulator device 221 may be configured to monitor the fluid pressure and automatically open so as to permit fluid flow through bypass channel 117. Bypass valve assembly 101 may also include a sensor to provide an operator with a visible or audible indication that regulator 221 has been opened. Any number of sensors and indicators may be used. In the preferred embodiment, regulator device is configured to measure the fluid pressure and notify the operator when regulator 221 breaches.

One end of coupling members 215a, 215b are configured to mate with connectors 207, 209 of valve 203. Valve assembly 201 is configured to couple to existing fluid valve systems, maintain existing styled connectors, and provide a bypass channel 217 with regulator device 221. It is understood that coupling members 215a, 215b may include any type of connectors. Furthermore, in other embodiments, connectors 211, 213 may not be similar in form and function to connectors 207, 209 respectively.

In operation, when plug 208 is open, pressure spikes and pressure variations are configured to pass with the fluid through a central channel of body 206. However, when plug 208 is closed, the fluid becomes relatively stagnant. Pressure variations and pressure spikes are absorbed by body 206 and other portions of valve assembly 201. As stated previously, bypass valve assembly 201 and valve 203 are configured to withstand a maximum pressure before failure. When fluid pressures exceed a preselected pressure level, regulator device 221 is configured to rupture or open so as to permit the passage of fluid externally around valve 203 through channel 217. Ideally, regulator 221 is configured to maintain a maximum pressure rating lower than the maximum pressure rating of valve 203. Regulator 221 acts as a safety feature to prevent the failure of valve assembly 201 and valve 203 during pressure spikes when the valve is closed. It is understood that valve assembly 201 may be used with other types of valve bodies aside from that of plug valve 203, for example valve assembly 101. It is also understood that different types and sizes of regulator device 221 are possible within valve assembly 201. Valve assembly 101 may interchange regulator device 119 with other similar devices. This interchangeable feature allows the operator the ability to customize the preselected permitted maximum pressure level according to the type of valve in use.

It is understood that the shape of valve assembly 201 may be modified or adjusted to operate in different environments. Furthermore, although one regulator 119, 221 has been shown to operate with valve assemblies 101, 201, it is understood that one or more regulators 119, 221 may be used. Additionally, sensors and indicators/notifications used in valve assembly 101 may also be used in valve assembly 201.

The particular embodiments disclosed above are illustrative only, as the invention may be modified and practiced in different but equivalent manners apparent to those skilled in the art having the benefit of the teachings herein. It is therefore evident that the particular embodiments disclosed above may be altered or modified, and all such variations are considered within the scope and spirit of the invention. Accordingly, the protection sought herein is as set forth in the description. It is apparent that an invention with significant advantages has been described and illustrated. Although the present invention is shown in a limited number of forms, it is not limited to just these forms, but is amenable to various changes and modifications without departing from the spirit thereof.

What is claimed is:

1. A bypass valve assembly, comprising:
a valve body configured to regulate the flow of fluid through the use of a valve, the fluid passing through a central channel in the valve body; and
a bypass housing coupled to the valve body and configured to regulate the maximum level of fluid pressure within the valve body so as to prevent failure, the bypass housing having a bypass channel in fluid communication with the central channel; and
a regulator device located within the bypass channel and configured to selectively permit fluid flow around the valve in response to fluid pressure levels.

2. The bypass valve assembly of claim 1, wherein the valve operates between and open orientation and a closed orientation, the open orientation permits the fluid flow through the central channel, the closed orientation prevents fluid flow through the central channel.

3. The bypass valve assembly of claim 2, wherein the regulator device is configured to rupture when the fluid pressure exceeds a preselected level when the valve is in the closed orientation.

4. The bypass valve assembly of claim 1, wherein the valve body further includes an upstream auxiliary channel and a downstream auxiliary channel, each auxiliary channel in fluid communication between the central channel and the bypass channel; and wherein the upstream auxiliary channel is upstream of the valve and the downstream auxiliary channel is downstream of the valve.

5. The bypass valve assembly of claim 4, wherein the upstream auxiliary channel and the downstream auxiliary channel are unobstructed by the valve.

6. The bypass valve assembly of claim 1, wherein the regulator device is a mechanical device configured to rupture automatically from the fluid pressure.

7. The bypass valve assembly of claim 1, further comprising:
a tube plug configured to permit access within the bypass channel when the bypass housing is coupled to the valve body.

8. The bypass valve assembly of claim 1, further comprising:
a sensor configured to detect the fluid flow through the bypass channel and notify an operator of the fluid flow through the bypass channel.

9. The bypass valve assembly of claim 8, wherein the sensor is coupled to the bypass housing.

10. The bypass valve assembly of claim 8, wherein the sensor is coupled to the regulator device.

11. A bypass valve assembly, comprising:
a first coupling member configured to couple to a first tube for the transportation of a fluid through a first central passage, the coupling member having a first fitting configured to mate with the first tube;
a second coupling member configured to couple to a second tube for the transportation of a fluid through a second central passage, the coupling member having a second fitting configured to mate with the second tube
a first bypass tube having a first bypass passage in fluid communication with the first central passage;
a second bypass tube having a second bypass passage in fluid communication with the second central passage; and
a regulator device in sealing engagement between the first bypass tube and the second bypass tube, the regulator device configured to selectively permit the flow of fluid through the first bypass tube and second bypass tube when the fluid pressure exceeds a predetermined level.

12. The bypass valve assembly of claim 11, wherein the first coupling member is coaxial with the second coupling member.

13. The bypass valve assembly of claim 11, wherein the regulator device is a mechanical device configured to rupture automatically as the fluid pressure exceeds the predetermined level.

14. The bypass valve assembly of claim 11, wherein the regulator device is configured to monitor the fluid pressure and automatically open so as to permit fluid flow between the first bypass passage and the second bypass passage.

15. The bypass valve assembly of claim 11, wherein the regulator device is configured to provide an operator with a visible or audible indication that regulator 221 has been ruptured.

16. The bypass valve assembly of claim 11, wherein the regulator device is interchangeable.

17. The bypass valve assembly of claim 11, further comprising:
a valve coupled to the first fitting and the second fitting, the valve being in fluid communication with the first central passage and the second central passage.

18. The bypass valve assembly of claim 17, wherein the valve operates between and open orientation and a closed orientation, the open orientation permits the fluid flow through the valve between the first central passage and the second central passage, the closed orientation prevents fluid flow through the first central passage and the second central passage.

19. The bypass valve assembly of claim 18, wherein the regulator device is configured to rupture when the fluid pressure exceeds a preselected level when the valve is in the closed orientation.

20. The bypass valve assembly of claim 17, wherein the regulator device is selected based upon operational limitations of the valve, the regulator device is interchangeable to adjust the predetermined level of allowed fluid pressure.
